(19) United States
(12) Patent Application Publication
(10) Pub. No.: US 2013/0091006 A1
(43) Pub. Date: Apr. 11, 2013

(54) Communication System For Controlling Network Access Through Access Point By Using Advertisement

(71) Applicants: Young Shin Kim, Seoul (KR); Heung Soo Park, Namyangju-si (KR)

(72) Inventors: Young Shin Kim, Seoul (KR); Heung Soo Park, Namyangju-si (KR)

(73) Assignees: NEOMTECH CO., LTD., Seoul (KR); HANWHA SOLUTION & CONSULTING CO., LTD., Seoul (KR)

(21) Appl. No.: 13/288,066

(22) Filed: Nov. 3, 2011

(30) Foreign Application Priority Data
Oct. 7, 2011 (KR) 10-2011-0102308

(51) Int. Cl. G06Q 30/02

(52) U.S. Cl. 705/14.39; 705/14.73; 705/14.58

(57) ABSTRACT

Provided is a communication system and method that may control a network access through an access point (AP) using an advertisement. The communication system may include an advertisement server to maintain an advertisement database (DB), and an internet sharer to control an access by a terminal to a network. The internet sharer may receive an advertisement from the advertisement server so as to provide the advertisement to the terminal when a request for a network access is received from the terminal, and may allow the terminal to access the network when the advertisement is executed in the terminal.

### CROSS-REFERENCE TO RELATED APPLICATION

This application claims the benefit of Korean Patent Application No. 10-2011-0102308, filed on Oct. 7, 2011, in the Korean Intellectual Property Office, the disclosure of which is incorporated herein by reference.

### FIELD OF THE INVENTION

The present invention relates to a communication system and method that may control a network access so as to enable users to use a wired/wireless access point (AP) installed in a public place.

### BACKGROUND OF THE INVENTION

Recently, demand from users for mobile internet service or broadband wireless local area network (LAN) service that enables data communication through the Internet and enables long distance communication, for example, a mobile phone service, has increased significantly.

The wireless LAN may be referred to as a wireless fidelity (Wi-Fi) including a meaning that use of a wireless network is as convenient as use of a high fidelity (Hi-Fi) audio. A personal digital assistant (PDA) or a laptop computer may use the Internet within a predetermined distance based on a location at which an access point (AP) is installed.

Although a range of a radio wave initially extended to a mere 10 meters (m), the range has been extended to 50 m and even up to a few hundreds of meters, in recent times.

The wireless LAN, which has a high potential to be an open-type wireless network, has become popular, along with a terminal. Also, a Wi-Fi, has been utilized to provide a high speed data service throughout an entire city by way of being installed in public settings, for example, schools, airports, hotels, and the like.

Korean patent No.10-2005-0106979, published on Nov. 11, 2005, discloses a technology for providing a wireless internet service based on a wireless LAN.

To provide a smooth communication service through a wireless communication network, mobile communication service providers establish free Wi-Fi zones in many public places, for their customers. The purpose of establishing the Wi-Fi zones being, to support a network speed and to decrease a load on a 3G network, as opposed to making a profit.

Also, a great number of wireless APs have been installed in public places, for example, coffee houses and the like, and are provided as a complimentary service for users as opposed to as a profit model.

A conventional wireless LAN provides, at a low cost, an improved transmission speed so as to transmit and receive high capacity multi-media information. However, terminals subscribing to a service of a predetermined mobile communication company are merely allowed to use the APs installed in the public places.

To use the wireless APs installed in the public places, a terminal may be required to subscribe to a service of a predetermined communication company. Also, a mobile communication company may verify whether a terminal is registered in the mobile communication company and may allow only the registered terminal to access a network. Accordingly, the wireless internet service has been limited.

Therefore, there is a desire for a communication system that allows a network access so that users who desire to use wired or wireless APs installed in a public place are able to use the wired or wireless APs.

### SUMMARY OF THE INVENTION

An aspect of the present invention provides a communication system and method that controls a network access so that anyone is able to access a network through a wired/wireless access point (AP) installed in a public place.

Another aspect of the present invention also provides a communication system and method that allows a user to access a wired/wireless AP installed in a public place when the user views an advertisement.

Another aspect of the present invention also provides a communication system and method to provide a profit model appropriate for a manager of a public place where a wired/wireless AP is installed or an installer of the AP.

According to an aspect of the present invention, there is provided an internet sharer that controls an access to a network by a terminal, the internet sharer including an advertisement provider to provide, to the terminal, an advertisement provided from an advertisement server, through a connection with the advertisement server when a request for network access is received from the terminal, and an access controller to allow the terminal to access the network when the advertisement is executed in the terminal.

The advertisement server may provide at least one advertisement associated with a location where the internet sharer is installed.

The advertisement server may provide an advertisement including at least one of coupon information, discount information, and product information associated with a location where the internet sharer is installed.

The internet sharer may further include a storage unit to store the advertisement, and the advertisement provider may provide, to the terminal, the advertisement stored in the storage unit, in response to the request for network access transmitted from the terminal.

According to another aspect of the present invention, there is provided a communication system, including an advertisement server to maintain an advertisement database (DB), and an internet sharer to control an access by a terminal to a network, and the internet sharer may receive an advertisement from an advertisement server when a request for network access is received from the terminal, and may allow the terminal to access the network when the advertisement is executed in the terminal. Also, the advertisement server may provide an advertisement including at least one of coupon information, discount information, and product information associated with a location where the internet sharer is installed.

According to still another aspect of the present invention, there is provided a communication method, including requesting, by an internet sharer, an advertisement server to provide an advertisement when a request for a network access is received from a terminal, providing, by the advertisement server, at least one advertisement associated with a place where the internet server is installed, receiving, by the internet sharer from the advertisement server, the advertisement so as to provide the received advertisement to the terminal, and allowing the terminal to access a network when the advertisement is executed in the terminal.

Additional aspects, features, and/or advantages of the invention will be set forth in part in the description which follows and, in part, will be apparent from the description, or may be learned by practice of the invention.

According to embodiments of the present invention, a network access through a wired/wireless access point (AP) installed in a public place may be controlled using an advertisement and thus, the network access may be open to all users who view an advertisement and the users may be allowed to access the AP at no cost.

According to embodiments of the present invention, an advertisement may be provided to a user who desires to access a network through a wired/wireless AP installed in a public place, a profit obtained by the advertisement may be provided to a provider of the public place, for example, a manager or an installer, and thus, a profit model appropriate for the provider may be provided and a profitability and a usability of the wired/wireless AP may increase.

According to embodiments of the present invention, information associated with a store where a wired/wireless AP is installed is transmitted to customers visiting the store by providing an advertisement associated with the store, so as to encourage spending, and thus, a usability of an AP may increase and a number of requests for installation of an AP may be increased.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a communication system that controls an access to a network connected to an internet sharer using an advertisement according to an embodiment of the present invention;

FIG. 2 is a diagram illustrating a configuration of an internet sharer that controls a network access using an advertisement according to an embodiment of the present invention; and

FIG. 3 is a flowchart illustrating a communication method that controls an access to a network connected to an internet sharer using an advertisement according to an embodiment of the present invention.

### DETAILED DESCRIPTION OF THE INVENTION

Reference will now be made in detail to embodiments of the present invention, examples of which are illustrated in the accompanying drawings, wherein like reference numerals refer to the like elements throughout. Embodiments are described below to explain the present invention by referring to the figures.

Embodiments of the present invention may be applicable to a network system that enables at least one terminal to simultaneously access the Internet by sharing a single internet line.

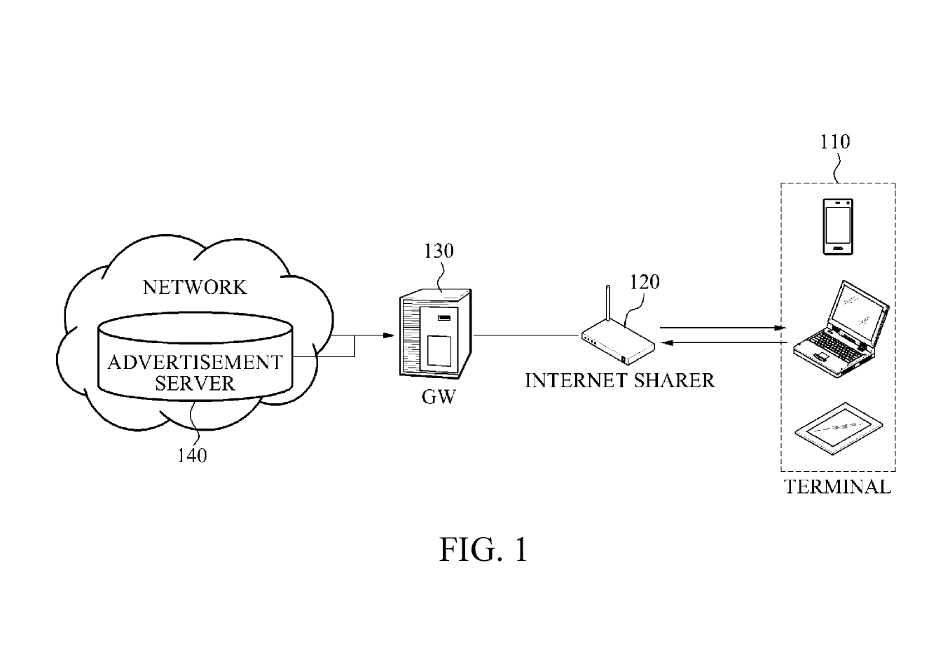

FIG. 1 illustrates a communication system that control an access to a network connected to an internet sharer using an advertisement according to an embodiment of the present invention. As illustrated in FIG. 1, the communication system may include an internet sharer 120, a gate way (GW) 130, and an advertisement server 140.

The internet sharer 120 may refer to a wired or wireless access point (AP), and may control an access by a plurality of terminals 110 to a network. In this example, the internet sharer 120 may be installed in public settings which accommodate many users, for example, subway stations, schools, airports, hotels, coffee houses, restaurants, and the like. The internet sharer 120 may be operated based on wireless local area network (LAN) technologies including a radio scheme using radio technologies and an infrared light scheme using a light, in addition to wired LAN technologies. The wireless LAN technologies may include varied standards. Although IEEE 802.11b using a wireless RF technology is currently determined to be a standard for 11 megabytes per second (Mbps), the embodiments of the present invention are not limited to the communication scheme thereof. The terminal 110 may refer to any communication terminal that is capable of accessing a network, for example, a personal computer (PC), a laptop computer, a tablet, a smart-phone, and the like.

A user who desires to access a network in a public place where the internet sharer 120 is installed may request a network access from the internet sharer 120 using the terminal 110. In this example, the internet sharer 120 may determine the terminal 110 that requests the network access, and may access the advertisement server 140 through the GW 130 so as to request provision of an advertisement.

The advertisement server 140 may refer to a server system that establishes an advertisement DB, and may provide an advertisement to the terminal 110 through the internet sharer 120 in response to the request by the internet sharer 120. The advertisement server 140 may randomly extract and provide an advertisement, or may provide a matching advertisement, selectively, based on the place where the internet sharer 120 is installed. The advertisement server 140 may provide at least one advertisement, selectively, associated with the place where the internet sharer 120 is installed, and the advertisement may include at least one of coupon information, discount information, and product information associated with the place.

The internet sharer 120 may receive the advertisement from the advertisement server 140, and may provide the received advertisement to the terminal 110. When the advertisement is executed in the terminal 110, the terminal 110 may be allowed to access the network. When the user desires to use the internet sharer 120 installed in the public place, the user may use, through the terminal 110, the network connected to the internet sharer 120 freely, by viewing the advertisement through the terminal 110.

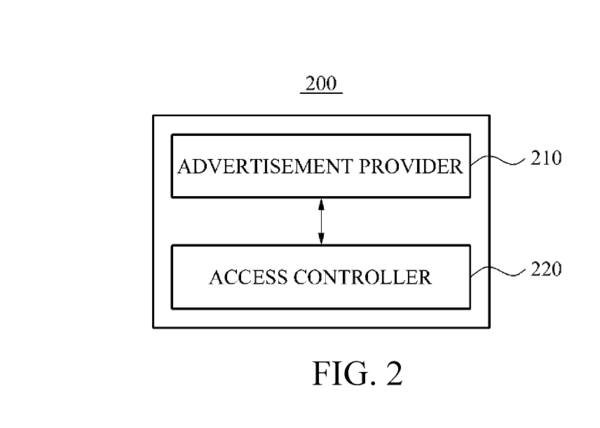

FIG. 2 illustrates a configuration of an internet sharer that controls a network access using an advertisement according to an embodiment of the present invention. Referring to FIG. 2, an internet sharer 200 may include an advertisement provider 210 and an access controller 220.

The advertisement provider 210 may receive an advertisement from an advertisement server through a connection with the advertisement server when a request for network access is received from a terminal. In this example, the advertisement provided by the advertisement server may include at least one advertisement associated with a location where the internet sharer 200 is installed. In addition, the advertisement provided by the advertisement server may be an advertisement that advertises the place, directly, where the internet sharer 200 is installed, and the advertisement may include at least one of coupon information, discount information, and product information.

The access controller 220 may control an access to the network by the terminal, and may allow the terminal to access the network when an advertisement is executed in the terminal. That is, when a user performs an action to utilize an advertisement directly, for example, clicking on an advertisement on the terminal, playing back a video clip included in an advertisement, and executing an advertisement page viewer, the access controller 220 may recognize the action and may allow the corresponding terminal to access a network.

In some embodiments, the internet sharer 200 may additionally include a storage unit (not illustrated) to store an advertisement content. When the storage unit corresponding to an additional memory space is included in the internet sharer 200, the advertisement provider 210 may read an advertisement stored in the storage unit and may transfer the read advertisement to a corresponding terminal when a request for network access is received from the corresponding terminal.

Therefore, the internet sharer 200 may utilize an advertisement stored in an internal memory, in addition to an advertisement provided by an advertisement server, as a medium to allow a terminal to access a network in response to a network access transmitted from the terminal.

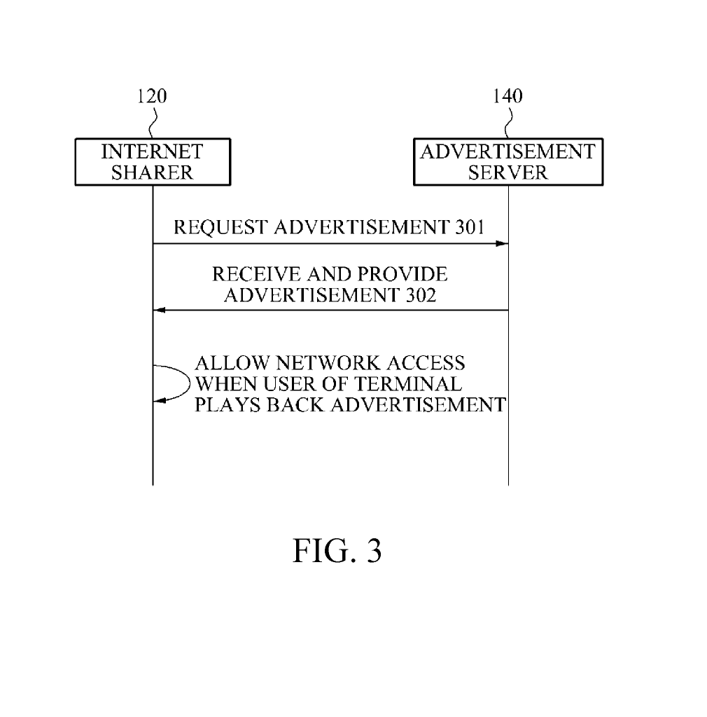

FIG. 3 illustrates a communication method that controls an access to a network connected to an internet sharer using an advertisement according to an embodiment of the present invention. Here, the communication method may be performed by a communication system including the internet sharer 120 and the advertisement server 140 of FIG. 1.

When a request for network access is received from a terminal, the internet sharer 120 may determine the terminal accessing the internet sharer 120, and may access the advertisement server 140 so as to request an advertisement from the advertisement server 140 in operation 301.

In response to the request by the internet sharer 120, the advertisement server 140 may select at least one advertisement among advertisements stored in an advertisement DB, and may provide the at least one advertisement to the terminal through the internet sharer 120. That is, the internet sharer 120 may receive an advertisement provided by the advertisement server 140 and may transfer the received advertisement to the terminal in operation 302. In this example, the advertisement server 140 may provide at least one advertisement associated with a place where the internet sharer 120 is installed, and the advertisement may include at least one of coupon information, discount information, and product information associated with the place. When a storage unit to store advertisement content is included in the internet sharer 120, the internet sharer 120 may read an advertisement stored in the storage unit and may transmit the read advertisement to a corresponding terminal in response to a request for network access transmitted from the corresponding terminal.

When the advertisement is played back in the terminal, the internet sharer 120 may allow the terminal that requests the network access to access the network in operation 303. That is, when a user of the terminal views an advertisement through the terminal, the user may be able to utilize a network connected to the internet sharer 120 through the corresponding terminal.

Therefore, according to embodiments of the present invention, an advertisement may be provided to users who attempt to access an internet sharer installed in a public place, and users who view the provided advertisement may be allowed to utilize the Internet through the corresponding internet sharer.

Also, embodiments of the present invention may provide a profit model that distributes, to a provider of a public place where an internet sharer is installed, a predetermined portion of a profit obtained by providing an advertisement to control a network access.

In addition, the embodiments of the present invention may encourage spending by allowing customers to use the Internet through an internet sharer installed in a store, through providing an advertisement associated with the store, for example, varied coupons available in the store, discount information, information associated with a new menu, and the like, when the customers visiting the store attempt to access the internet sharer installed in the store.

The method according to the above-described embodiments of the present invention may be recorded in non-transitory computer readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Also, the file system may be recorded in the non-transitory computer readable media.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An internet sharer that controls an access by a terminal to a network, the internet sharer comprising:
an advertisement provider to provide, to the terminal, an advertisement provided from an advertisement server, through a connection with the advertisement server when a request for network access is received from the terminal; and
an access controller to allow the terminal to access the network when the advertisement is executed in the terminal.

2. The internet sharer of claim 1, wherein the advertisement server provides at least one advertisement associated with a location where the internet sharer is installed.

3. The internet sharer of claim 1, wherein the advertisement server provides an advertisement comprising at least one of coupon information, discount information, and product information associated with a location where the internet sharer is installed.

4. The internet sharer of claim 1, wherein:
the internet sharer further comprises a storage unit to store the advertisement, and
the advertisement provider provides, to the terminal, the advertisement stored in the storage unit, in response to the request for network access transmitted from the terminal.

5. A communication system, comprising:
an advertisement server to maintain an advertisement database (DB); and
an internet sharer to control an access by a terminal to a network,
wherein the internet sharer receives an advertisement from an advertisement server when a request for network access is received from the terminal, and allows the terminal to access the network when the advertisement is executed in the terminal.

6. The communication system of claim 5, wherein the advertisement server provides an advertisement comprising at least one of coupon information, discount information, and product information associated with a location where the internet sharer is installed.
